(19) United States
(12) Patent Application Publication
(10) Pub. No.: US 2014/0345144 A1
(43) Pub. Date: Nov. 27, 2014

(54) KNIFE WITH A ROTATING IMPLEMENT

(71) Applicant: Spencer Frazer, Lynnwood, WA (US)

(72) Inventor: Spencer Frazer, Lynnwood, WA (US)

(21) Appl. No.: 14/214,724

(22) Filed: Mar. 15, 2014

Related U.S. Application Data
(60) Provisional application No. 61/802,273, filed on Mar. 15, 2013.

(51) Int. Cl. B26B 29/02; B26B 3/00

(52) U.S. Cl. CPC B26B 29/02; B26B 3/00
USPC 30/153

(57) ABSTRACT

A knife with a rotating implement is disclosed. In some embodiments, the knife has a blade with a tang and a knife edge, a handle having a first cavity to receive the tang of the blade and a second cavity to receive a rotating implement, the handle further having a pivot to receive a rotating implement; and a rotating implement connected to the pivot, the rotating implement having a sheath cover to cover the knife edge when the rotating implement is pivoted to an extended position, wherein the rotating implement is stowed in the second cavity in the handle when a stowed position.

### RELATED APPLICATIONS

This application claims the benefit of U.S. Provisional Application No. 61/802,273, filed Mar. 15, 2013.

### BACKGROUND

Knives are currently made with gut hooks or other specific use edges built into a portion of the blade. For example, hunting knives often have a gut hook portion on a top ridge of the knife blade opposite the knife blade cutting edge. These permanent specific use edges are designed to function for their specific use, but may hinder use of the knife for other purposes. In the hunting knife and gut hook example, the gut hook could accidently cut an undesirable part of an animal during cleaning or skinning, or may cause injury to the knife wielder.

### SUMMARY

Accordingly, a knife with a rotating implement is described below in the Detailed Description. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a plan view of an embodiment knife with a rotating implement in the extended position.

FIG. 2 is a section view of an embodiment knife in FIG. 1 with a rotating implement in the extended position.

FIG. 3 is a section view of an embodiment knife in FIG. 1 with a rotating implement in a partially extended position.

FIG. 4 is a section view of an embodiment knife in FIG. 1 with a rotating implement in a stowed position.

FIG. 5 is a plan view of an embodiment knife with a spring and rotating implement in the extended position.

FIG. 6 is a plan view of an embodiment knife with a spring and rotating implement in a stowed position.

FIG. 7 is a plan view of an embodiment knife with a slip joint and a rotating implement in the extended position.

FIG. 8 is a plan view of an embodiment knife with a slip joint and a rotating implement in the partially extended position.

### DETAILED DESCRIPTION

A disclosed knife can include a lockable tool, such as a gut hook or a line cutter, etc., which is rotatable from a handle of the knife to a usable position. Additionally, the rotating element may function as a sheath that is rotatable from the handle of the knife into a locked position over the blade. In this way, the disclosed knife comprises a rotating element which is stored within the handle when not in use. In some embodiments there may be a side piston lock which can retain the rotating element in the handle and can also be used to retain the rotating element in the open or usable positions.

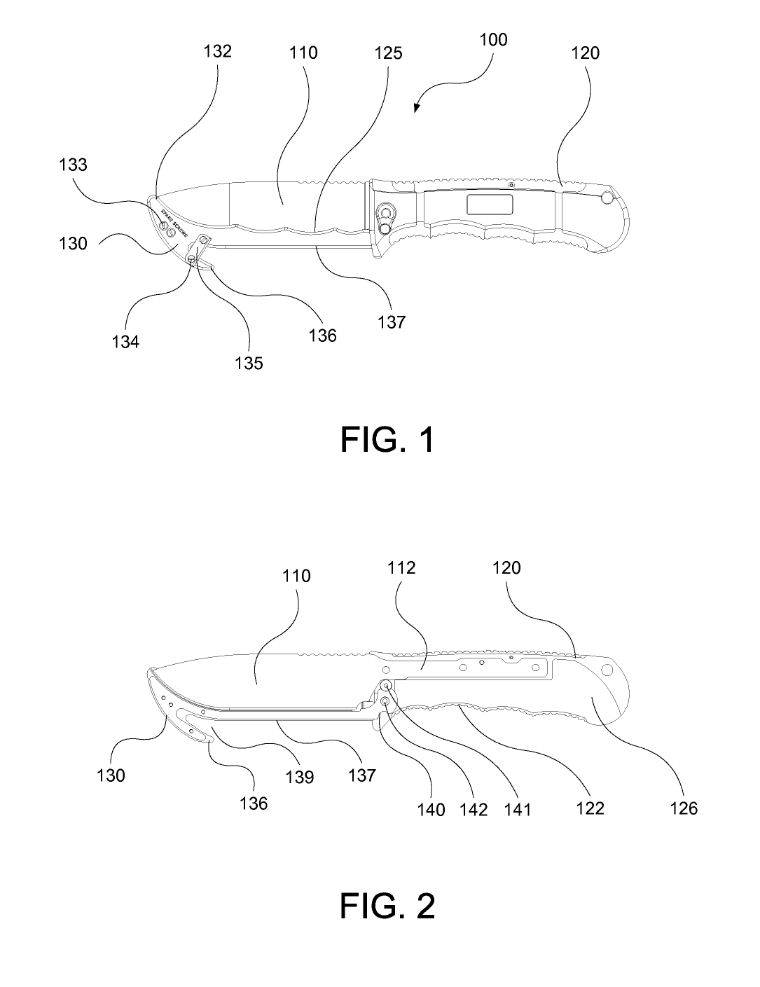

Conventional hunting knives have a gut hook on the top ridge of the knife. It is not always desirable to have a gut hook on the top edge of the knife since this feature could accidently cut an undesirable part of an animal during cleaning or skinning The disclosed knife allows a hunter to deploy the gut hook only when it is desired to be used and at other times have the gut hook stored away within the handle of the knife. Additionally, this provides a sheath to cover the knife blade while the gut hook is being used to not cause inadvertent cuts from the knife blade during use of the gut hook. The present embodiment describes a gut hook, but other deployable tools may be used in accordance with the principles of this disclosure. Additionally, the tools or sheath could be manually deployable or they could be spring actuated either to an open or shut orientation, or to both orientations. We now turn to FIG. 1 to describe one embodiment.

FIG. 1 is a plan view of an embodiment knife with a rotating implement in the extended position. Knife 100 in FIG. 1 includes a handle 120, a blade 110, and a rotating implement 130. In this embodiment, rotating implement 130 includes a blade sheath 137, a fingerguard 125, a gut hook 135 fastened to rotating implement 130 using one or more screws 134, and spare screws 133. The rotating implement 130 is coupled to the knife handle 120 by pivot 142, as shown in FIG. 2. In the illustrated embodiment, the point 136 of the rotating implement 130 is stowed in the handle 120 between the end of the tang and the butt of the handle. In some embodiments, a short blade tang may be used to allow a larger rotating implement to be stowed in the handle, but other embodiments are not so limited and a longer tang may be used and the rotating implement may be stowed adjacent to the tang.

In some embodiments, a knife may have a blade 110 having a tang 112 and a knife edge 114, a handle 120 having a first cavity to receive the tang of the blade and a second cavity to receive a rotating implement, the handle further having a pivot 142 to receive a rotating implement 130. The illustrated embodiments also include a rotating implement 130 connected to the pivot 142, the rotating implement having a sheath 137 to cover the knife edge 114 when the rotating implement 130 is pivoted to an extended position, wherein the rotating implement is stowed in the second cavity in the handle when a stowed position. In the illustrated embodiment, rotating implement 130 includes a gut hook 135; however other embodiments are not so limited. As an example, the rotating implement can simply be a rotating sheath that can be stowed in the knife handle, or other tools may be utilized on the rotating implement.

FIG. 2 is a section view of an embodiment knife in FIG. 1 with a rotating implement in the extended position. In this section view, rotating element 130 is shown comprising a point 136, a gap 139, sheath 137, and indentation 140. Indentation 140 is configured to align with post 141 when the rotating element is enclosed in the handle to secure the rotating element 130 into place. The handle includes pivot 142 that connects the rotating element 130, post 141, blade tang 112, handle back 120, and cavity 126 that receives the rotating element 130 when it is stowed within the handle.

In the illustrated embodiment, the rotating implement 130 is contoured in the shape of the knife blade. In this way, the sheath 137 can provide protection over a greater portion of the knife blade. In some embodiments, the sheath may cover the entire knife blade and the point of the knife, but other embodiments may cover only portions of the knife blade. For example, a rotating implement may have a notch that allows a portion of the knife edge to be used to cut lines, wires, or other materials.

In some embodiments, blade 110 may be an exchangeable blade that can be installed into handle 120 and changed out using a replaceable blade mechanism. For example, handle 120 may have a moveable piston that fits within a hole defined in the blade tang, and the handle can receive the blade tang securely using the cavity of the handle receiving the tang and the piston extending through the hole defined in the blade tang. Other blade fastening systems may also be used in accordance with the principles of this disclosure.

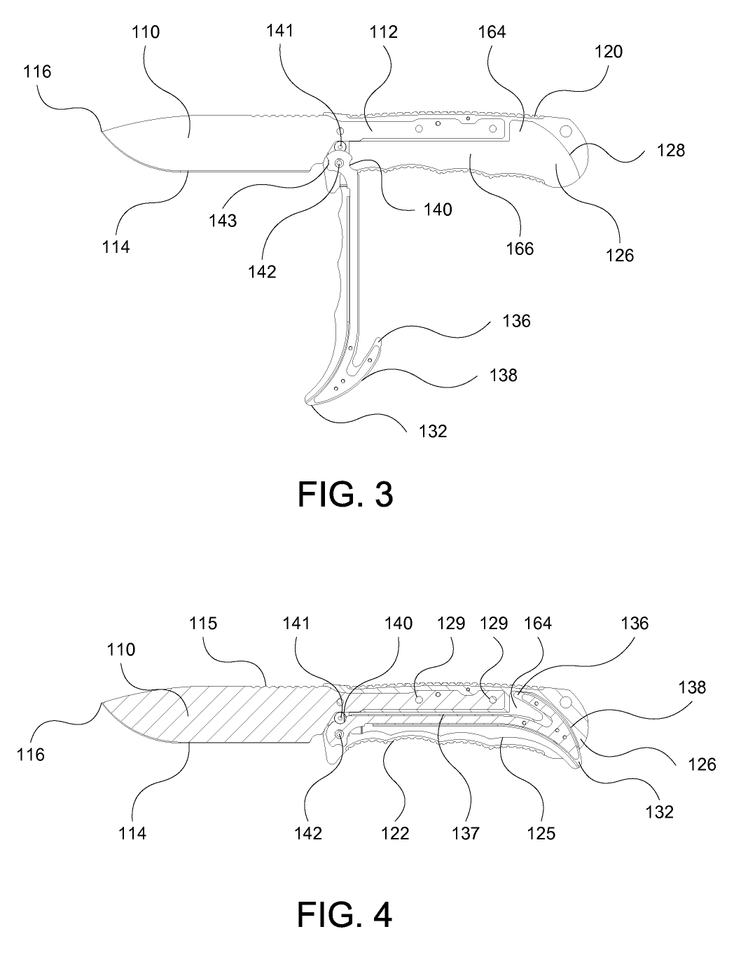

FIG. 3 is a section view of an embodiment knife in FIG. 1 with a rotating implement in a partially extended position. FIG. 3 illustrates the rotating element in a half-open or half-closed position. In this position, indentation 140 and indentation 143 are not adjacent post 141 and the rotating element is free to move to a closed or an open position. FIG. 4 is a section view of an embodiment knife in FIG. 1 with a rotating implement in a stowed position. In this sectional view, the rotating element has been moved to a closed position and is stowed within the handle 120. Additionally, post 141 is seated within indentation 140 of rotating element 130, thus securing rotating element 130 into the handle. In this orientation, the fingerguard front 125 of the rotating element aligns with the fingerguard 122 of handle 120. In some embodiments rotating element 130 may be spring assisted to one or both of an open or a closed position.

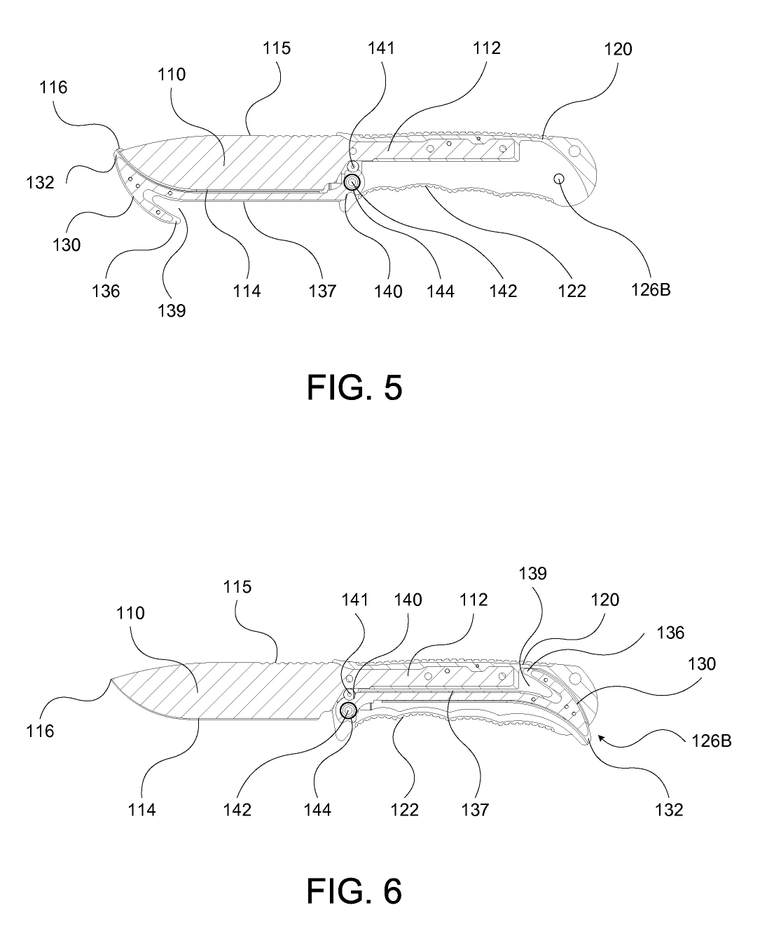

FIG. 5 is a section view of an embodiment knife with a spring 144 and a rotating implement in the extended position. The knife includes a handle 120, a blade 110, and a rotating implement 130. In this embodiment, rotating implement 130 includes a blade sheath 137, a gut hook 135 as a component to rotating implement 130. The rotating implement 130 is coupled to the knife handle 120 by pivot 142. In this embodiment the spring 144 may be used to open the rotating implement 130 from a stowed position to an extended position or to retract the rotating implement 130 from the extended position to a stowed position. In some embodiments, one or more springs may be used to open and close the rotating implement. Additionally, in some embodiments the rotating implement may be stowed or extended with a spring in a stored energy state and it may have a release mechanism, button, latch, etc., such that when the release mechanism is used the stored energy will either open or close the rotating implement 130.

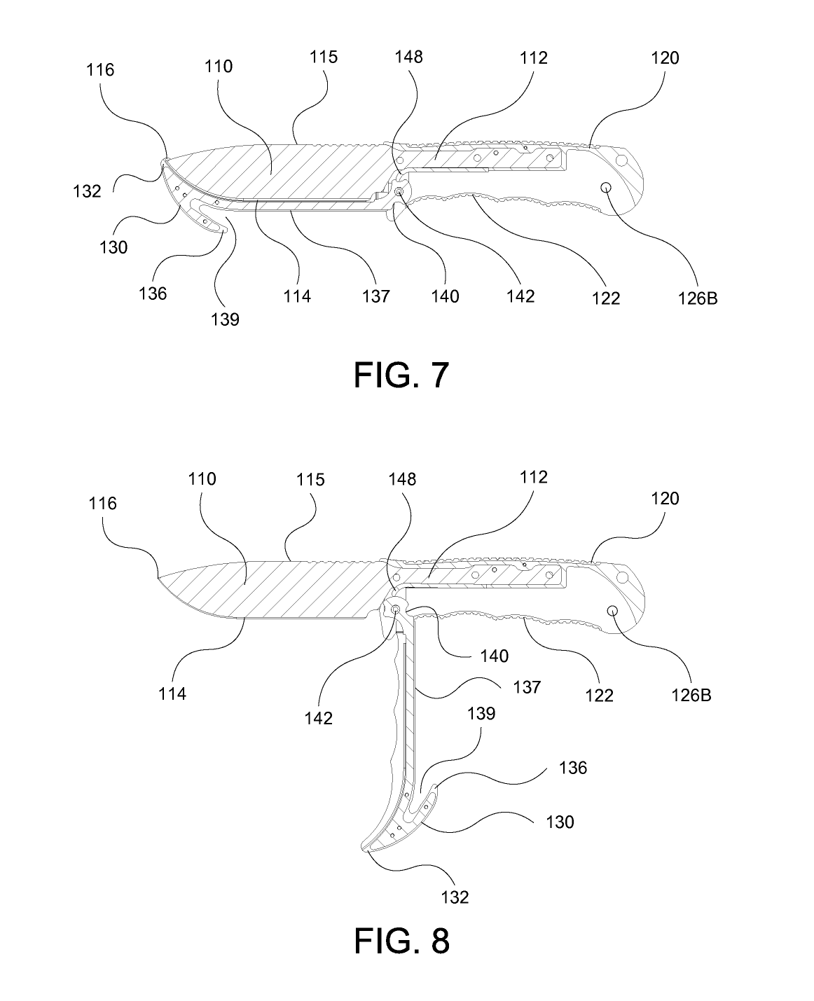

In some embodiments with or without a spring, the rotating implement 130 may have a lock mechanism to lock it in an extended position or in a stowed position, such as with indentation 140 and slip joint 148 as shown in FIGS. 7-8, or with a post 141 as in FIG. 1, or other locking mechanism. In some embodiments, a locking mechanism 126B may be used. For example, locking mechanism 126B may be a magnet or a friction fit to hold rotating implement 130 in a stowed position.

FIG. 6 is a section view of an embodiment knife with a spring 144 and rotating element 130 in a stowed position. In this section view, rotating element 130 is shown comprising a point 136, a gap 139, sheath 137, and indentation 140. Indentation 140 is configured to align with post 141 when the rotating element is enclosed in the handle to secure the rotating element 130 into place. The handle includes pivot 142 that connects the rotating element 130, post 141, blade tang 112, handle back 120, and cavity 126 that receives the rotating element 130 when it is stowed within the handle.

FIG. 7 is a plan view of an embodiment knife with a slip joint 148 and a rotating implement 130 in the extended position. Slip joint 148 can provide greater rotational resistance to the rotating implement 130 in the extended or stowed position by connecting with a contoured surface near the pivot point in rotating implement 130. Additionally, a slip joint 148 may glide more freely over a curved or cammed surface between indentations or contoured surfaces near the pivot point in the rotating implement. FIG. 8 is a plan view of an embodiment knife with a slip joint 148 and a rotating implement 130 in the partially extended position.

It will further be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A knife with a rotating implement comprising:
a blade having a tang and a knife edge;
a handle having a first cavity to receive the tang of the blade and a second cavity to receive a rotating implement, the handle further having a pivot to receive a rotating implement; and
a rotating implement connected to the pivot, the rotating implement having a sheath cover to cover the knife edge when the rotating implement is pivoted to an extended position, wherein the rotating implement is stowed in the second cavity in the handle when a stowed position.
